(19) United States
(12) Patent Application Publication
(10) Pub. No.: US 2018/0259934 A1
(43) Pub. Date: Sep. 13, 2018

(54) BUILDING MANAGEMENT SYSTEM WITH CUSTOM DASHBOARD GENERATION

(71) Applicant: Johnson Controls Technology Company, Plymouth, MI (US)

(72) Inventors: Ryan A. Piaskowski, Milwaukee, WI (US); Nicole A. Madison, Milwaukee, WI (US); Garrett Wiens-Kind, Milwaukee, WI (US); Beth A. Ray, Oak Creek, WI (US); Ann M. Cook, Hartland, WI (US)

(73) Assignee: Johnson Controls Technology Company, Plymouth, MI (US)

(21) Appl. No.: 15/454,562

(22) Filed: Mar. 9, 2017

(51) Int. Cl. G05B 19/409; G06F 3/0482; G05B 19/048

(52) U.S. Cl. CPC G05B 19/409; G06F 3/04845; G05B 19/048; G06F 3/0482

(57) ABSTRACT

A building management system includes building equipment configured to serve one or more spaces in a building or campus. A user device is configured to display a user interface for monitoring and controlling the building equipment and the one or more spaces. The building management system further includes a controller. The controller is configured to determine a role of a user to which the user interface will be displayed, a type of the user device on which the user interface will be displayed, and a type of equipment or space to be monitored and controlled via the user interface. The controller is further configured to select the user interface from a plurality of user interfaces, each user interface corresponding to a different combination of user role, user device type, and equipment type or space type. The controller is further configured to provide the selected user interface to the user device.

### BACKGROUND

The present disclosure relates generally to a user interface for viewing information relating to a building management system. A building management system (BMS) is, in general, a system of devices configured to control, monitor, and manage equipment in or around a building or building area. A BMS can include, for example, a heating, ventilation, and air conditioning (HVAC) system, a security system, a lighting system, a fire alerting system, any other system that is capable of managing building functions or devices, or any combination thereof.

Information about the BMS is typically accessed via a user interface generated by the BMS. A user may access the user interface via a user device such as a desktop, laptop, tablet, or mobile device. The user may generally access information about one or more spaces within the BMS, or one or more equipment within the BMS. For example, a user may view the current status of an area (e.g., occupancy, temperature, etc.), the current status of equipment (e.g., if equipment requires maintenance or replacement, if the equipment is malfunctioning), or any alarms or warning relating to the building or BMS.

The building or building area may be occupied by various personnel working in the building or building area. Each user may have different responsibilities or roles relating to the BMS, and may have different user permissions. For example, different users may be responsible for the oversight of different subsystems, some users may or may not be cleared to view information relating to a particular subsystem, and some users may need to actively provide input to the BMS while overseeing a particular subsystem. Accordingly, it would be desirable to have systems and methods for generating a user interface that is customizable based on the user viewing the user interface.

### SUMMARY

One implementation of the present disclosure relates to a building management system. The building management system includes building equipment configured to serve one or more spaces in a building or campus. The building management system further includes a user device configured to display a user interface for monitoring and controlling the building equipment and the one or more spaces. The building management system further includes a controller. The controller is configured to determine a role of a user to which the user interface will be displayed. The controller is further configured to determine a type of the user device on which the user interface will be displayed. The controller is further configured to determine at least one of a type of equipment and a type of space to be monitored and controlled via the user interface. The controller is further configured to select the user interface from a plurality of user interfaces based on the role of the user, the type of the user device, and at least one of the type of equipment and the type of space, each of the plurality of user interfaces corresponding to a different combination of user role, user device type, and at least one of equipment type and space type. The controller is further configured to provide the selected user interface to the user device.

Another implementation of the present disclosure relates to a building management system. The building management system includes building equipment configured to serve one or more spaces in a building or campus. The building management system further includes a user device configured to display a selected user interface for monitoring and controlling the building equipment and the one or more spaces. The building management system further includes a controller configured to generate a plurality of user interfaces from which the selected user interface is selected. The controller includes a widget module configured to generate a plurality of widgets, each of the widgets comprising information relating to at least one of the building equipment and the one or more spaces. The controller further includes a layout definition module configured to define a different layout for each of the plurality of user interfaces, wherein each layout comprises one or more of the widgets and corresponds to a different combination of a user role, a user device type, and at least one of an equipment type and a space type.

Another implementation of the present disclosure relates to a method for configuring a user interface to be displayed on a user device, the user interface configured to allow for the monitoring and controlling of building equipment and spaces in a building management system. The method includes determining a role of a user to which the user interface will be displayed. The method includes determining a type of the user device on which the user interface will be displayed. The method includes determining at least one of a type of equipment and a type of space to be monitored and controlled via the user interface. The method includes selecting the user interface from a plurality of user interfaces based on the role of the user, the type of the user device, and at least one of the type of equipment and the type of space. The method includes providing the selected user interface to the user device.

### BRIEF DESCRIPTION OF THE DRAWINGS

FIG. 1 is a high-level block diagram of a BMS, according to some embodiments.

FIG. 2 is a detailed block diagram of a BMS controller of a BMS and more particularly an interface customization manager of the BMS controller, according to some embodiments.

FIG. 3 is an example illustration of various user interface layouts that may be generated by the interface customization manager, according to some embodiments.

FIG. 4 is another example illustration of various user interface layouts that may be generated by the interface customization manager, according to some embodiments.

FIG. 5 is an example configuration interface that can be used by an administrator to create a user interface for a user, according to some embodiments.

FIG. 6 is another example configuration interface that can be used by an administrator to create a user interface for a user, according to some embodiments.

FIG. 7 is another example configuration interface that can be used by an administrator to create a user interface for a user, according to some embodiments.

FIG. 8 is another example configuration interface that can be used by an administrator to create a user interface for a user, according to some embodiments.

FIG. 9 is another example configuration interface that can be used by an administrator to create a user interface for a user, according to some embodiments.

FIG. 10 is an example interface for adding a new widget to a user interface, according to some embodiments.

FIG. 11 is a flow chart of a process for configuring a user interface to be displayed on a user device, according to some embodiments.

### DETAILED DESCRIPTION

Referring generally to the figures, systems and methods for custom configuration interface generation (e.g., customization of a “dashboard”) for a user interface are described, according to an exemplary embodiment. An administrator or other designated user may create a custom dashboard view on a user interface for different users associated with a BMS. The user interface may provide specialized views of the BMS for different users, tailored to the roles of each user, the one or more spaces associated with the user, and the one or more equipment in the BMS associated with the user. The custom dashboard view may generally include a user interface with a layout. The layout includes one or more widget, each widget corresponding with a particular building area, equipment, building system (e.g., a group of like equipment in the building), or task. Widgets may be associated with all users in a building, or to a subset of users in the building sharing a like role or responsibility. The layout may define how each widget is displayed in the user interface (e.g., the size, shape, and format of each widget), as well as which widgets are viewable for a particular user (or viewable by all users).

The custom dashboard generated for a user may take into account the role of the user in the BMS. For example, the user may be responsible for monitoring or maintaining a specific building area, or a specific piece of equipment, and the custom dashboard may be modified to provide only information relevant to the building area or equipment. As another example, some features of the custom dashboard may not be made available to the user if the user does not have the proper permissions, or if such features are not relevant to the user (i.e., a user without the technical expertise for maintaining a specific piece of equipment may not be provided technical detail about the equipment).

In some embodiments, an interface customization manager for generating the custom dashboard may determine one or more building areas or equipment relevant to the user (e.g., areas or equipment nearby the user), and provide relevant information about the building areas and equipment via the custom dashboard. For example, the BMS may determine the location of the user, and provide information about the building area the user is currently occupying. This information may further be tailored to the user's permissions (e.g., if the user is a manager or administrator, the user may be able to change settings within the building area he or she is occupying).

In some embodiments, the interface customization manager may determine the type of device the user is using to access the custom dashboard. The views on the custom dashboard (e.g., each widget within the user interface of the custom dashboard) may be adjusted based on the device type. For example, for a mobile device with a smaller screen, the layout may be arranged such that the most important widgets in the user interface are viewable. As another example, some views may only make sense for a desktop or larger screen, or for a mobile device or smaller screen. The same type of information may be presented via a graph or chart on a mobile table, and in table form on a desktop. As another example, icons, symbols, and the like can be used on mobile devices where space is limited, while large icons, text, and the like can be used on desktops. By determining the type of device, the interface customization manage may determine the size of each widget, and the layout of the content within each widget.

The various views provided by the BMS to an individual user may be customized by an administrator or other designated user. The administrator may assign particular layouts to particular types of users. For example, the administrator may assign a first layout to users who are responsible for the maintenance of equipment (tailoring the layout and widgets to show information regarding equipment performance and maintenance) and a second layout to users who are responsible for managing a building area (tailoring the layout and widgets to allow the users to provide, for example, a temperature setpoint for an area). Further, the administrator may assign particular layouts to different types of user devices (e.g., a default view for a desktop and laptop, a default view for a mobile device, etc.).

### Building Management System and HVAC System

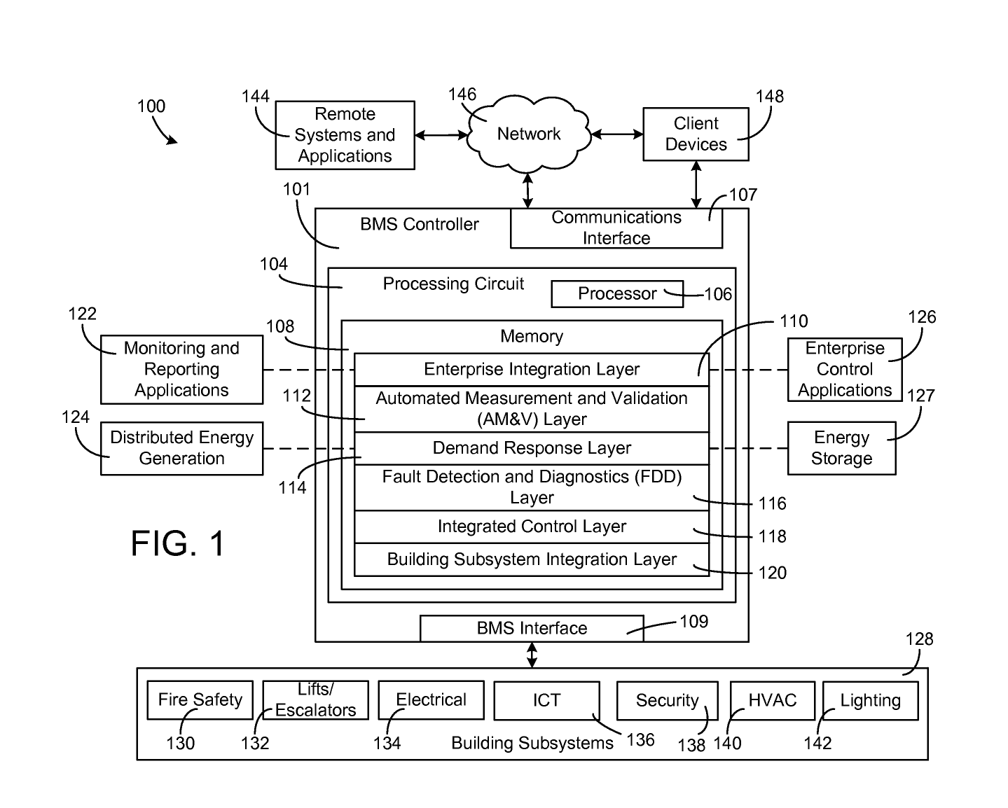

Referring now to FIG. 1, a block diagram of a BMS 100 is shown, according to an exemplary embodiment. BMS 100 is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof. BMS 100 is generally described in the present disclosure as serving a building or building area; in other embodiments BMS 100 may be configured to serve multiple buildings (e.g., a campus).

BMS controller 101 can include one or more computer systems (e.g., servers, supervisory controllers, subsystem controllers, etc.) that serve as system level controllers, application or data servers, head nodes, or master controllers for serving a building or building area. BMS controller 101 can communicate with multiple downstream building systems or subsystems (e.g., a HVAC system, a security system, a lighting system, etc.) via a communications link according to like or disparate protocols (e.g., LON, BACnet, etc.).

BMS 100 can be implemented in a building to automatically monitor and control various building functions. BMS 100 is shown to include a BMS controller 101 and a plurality of building subsystems 128. Building subsystems 128 are shown to include a fire safety subsystem 130, a lift/escalators subsystem 132, a building electrical subsystem 134, an information communication technology (ICT) subsystem 136, a security subsystem 138, a HVAC subsystem 140, and a lighting subsystem 142. In various embodiments, building subsystems 128 can include fewer, additional, or alternative subsystems. For example, building subsystems 128 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control a building. In some embodiments, building subsystems 128 and more particularly HVAC subsystem 140 can include a waterside system and/or an airside system.

Each of building subsystems 128 can include any number of devices, controllers, and connections for completing its individual functions and control activities. HVAC subsystem 140 can include, for example, a chiller, a boiler, any number of air handling units, economizers, field controllers, supervisory controllers, actuators, temperature sensors, and other devices for controlling the temperature, humidity, airflow, or other variable conditions within a building. Lighting subsystem 142 can include any number of light fixtures, ballasts, lighting sensors, dimmers, or other devices configured to controllably adjust the amount of light provided to a building space. Security subsystem 138 can include occupancy sensors, video surveillance cameras, digital video recorders, video processing servers, intrusion detection devices, access control devices (e.g., card access, etc.) and servers, or other security-related devices.

BMS controller 101 is shown to include a communications interface 107 and a BMS interface 109. Communications interface 107 can facilitate communications between BMS controller 101 and external applications (e.g., monitoring and reporting applications 122, enterprise control applications 126, remote systems and applications 144, applications residing on client devices 148, etc.) for allowing user control, monitoring, and adjustment to BMS controller 101 and/or subsystems 128. Communications interface 107 can also facilitate communications between BMS controller 101 and client devices 148. BMS interface 109 can facilitate communications between BMS controller 101 and building subsystems 128 (e.g., HVAC, lighting security, lifts, power distribution, business, etc.).

Interfaces 107, 109 can be or include wired or wireless communications interfaces (e.g., jacks, antennas, transmitters, receivers, transceivers, wire terminals, etc.) for conducting data communications with building subsystems 128 or other external systems or devices. In various embodiments, communications via interfaces 107, 109 can be direct (e.g., locally wired or wireless communications) or via a communications network 146 (e.g., a WAN, the Internet, a cellular network, etc.). For example, interfaces 107, 109 can include an Ethernet card and port for sending and receiving data via an Ethernet-based communications link or network. In another example, the interfaces 107, 109 can include a Wi-Fi transceiver for communicating via a wireless communications network. In another example, one or both of interfaces 107, 109 can include cellular or mobile phone communications transceivers. In one embodiment, communications interface 107 is a power line communications interface and BMS interface 109 is an Ethernet interface. In other embodiments, communications interface 107 and BMS interface 109 are Ethernet interfaces or are the same Ethernet interface.

BMS controller 101 is shown to include a processing circuit 104 including a processor 106 and memory 108. Processing circuit 104 can be communicably connected to BMS interface 109 and/or communications interface 107 such that processing circuit 104 and the various components thereof can send and receive data via interfaces 107, 109. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to an exemplary embodiment, memory 108 is communicably connected to processor 106 via processing circuit 104 and includes computer code for executing (e.g., by processing circuit 104 and/or processor 106) one or more processes described herein.

In some embodiments, BMS controller 101 is implemented within a single computer (e.g., one server, one housing, etc.). In various other embodiments BMS controller 101 can be distributed across multiple servers or computers (e.g., that can exist in distributed locations). Further, while FIG. 1 shows applications 122 and 126 as existing outside of BMS controller 101, in some embodiments, applications 122 and 126 can be hosted within BMS controller 101 (e.g., within memory 108).

Memory 108 is shown to include an enterprise integration layer 110, an automated measurement and validation (AM&V) layer 112, a demand response (DR) layer 114, a fault detection and diagnostics (FDD) layer 116, an integrated control layer 118, and a building subsystem integration later 120. Layers 110-120 can be configured to receive inputs from building subsystems 128 and other data sources, determine optimal control actions for building subsystems 128 based on the inputs, generate control signals based on the optimal control actions, and provide the generated control signals to building subsystems 128. The following paragraphs describe some of the general functions performed by each of layers 110-120 in BMS 100.

Enterprise integration layer 110 can be configured to serve clients or local applications with information and services to support a variety of enterprise-level applications. For example, enterprise control applications 126 can be configured to provide subsystem-spanning control to a graphical user interface (GUI) or to any number of enterprise-level business applications (e.g., accounting systems, user identification systems, etc.). Enterprise control applications 126 can also or alternatively be configured to provide configuration GUIs for configuring BMS controller 101. In yet other embodiments, enterprise control applications 126 can work with layers 110-120 to optimize building performance (e.g., efficiency, energy use, comfort, or safety) based on inputs received at interface 107 and/or BMS interface 109.

Building subsystem integration layer 120 can be configured to manage communications between BMS controller 101 and building subsystems 128. For example, building subsystem integration layer 120 can receive sensor data and input signals from building subsystems 128 and provide output data and control signals to building subsystems 128. Building subsystem integration layer 120 can also be configured to manage communications between building subsystems 128. Building subsystem integration layer 120 translates communications (e.g., sensor data, input signals, output signals, etc.) across a plurality of multi-vendor/multi-protocol systems.

Demand response layer 114 can be configured to optimize resource usage (e.g., electricity use, natural gas use, water use, etc.) and/or the monetary cost of such resource usage in response to satisfy the demand of a building. The optimization can be based on time-of-use prices, curtailment signals, energy availability, or other data received from utility providers, distributed energy generation systems 124, from energy storage 127, or from other sources. Demand response layer 114 can receive inputs from other layers of BMS controller 101 (e.g., building subsystem integration layer 120, integrated control layer 118, etc.). The inputs received from other layers can include environmental or sensor inputs such as temperature, carbon dioxide levels, relative humidity levels, air quality sensor outputs, occupancy sensor outputs, room schedules, and the like. The inputs can also include inputs such as electrical use (e.g., expressed in kWh), thermal load measurements, pricing information, projected pricing, smoothed pricing, curtailment signals from utilities, and the like.

According to an exemplary embodiment, demand response layer 114 includes control logic for responding to the data and signals it receives. These responses can include communicating with the control algorithms in integrated control layer 118, changing control strategies, changing setpoints, or activating/deactivating building equipment or subsystems in a controlled manner. Demand response layer 114 can also include control logic configured to determine when to utilize stored energy. For example, demand response layer 114 can determine to begin using energy from energy storage 127 just prior to the beginning of a peak use hour.

In some embodiments, demand response layer 114 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 114 uses equipment models to determine an optimal set of control actions. The equipment models can include, for example, thermodynamic models describing the inputs, outputs, and/or functions performed by various sets of building equipment. Equipment models can represent collections of building equipment (e.g., subplants, chiller arrays, etc.) or individual devices (e.g., individual chillers, heaters, pumps, etc.).

Demand response layer 114 can further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand set-point before returning to a normally scheduled set-point, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 118 can be configured to use the data input or output of building subsystem integration layer 120 and/or demand response later 114 to make control decisions. Due to the subsystem integration provided by building subsystem integration layer 120, integrated control layer 118 can integrate control activities of the subsystems 128 such that the subsystems 128 behave as a single integrated supersystem. In an exemplary embodiment, integrated control layer 118 includes control logic that uses inputs and outputs from a plurality of building subsystems to provide greater comfort and energy savings relative to the comfort and energy savings that separate subsystems could provide alone. For example, integrated control layer 118 can be configured to use an input from a first subsystem to make an energy-saving control decision for a second subsystem. Results of these decisions can be communicated back to building subsystem integration layer 120.

Integrated control layer 118 is shown to be logically below demand response layer 114. Integrated control layer 118 can be configured to enhance the effectiveness of demand response layer 114 by enabling building subsystems 128 and their respective control loops to be controlled in coordination with demand response layer 114. This configuration may advantageously reduce disruptive demand response behavior relative to conventional systems. For example, integrated control layer 118 can be configured to assure that a demand response-driven upward adjustment to the set-point for chilled water temperature (or another component that directly or indirectly affects temperature) does not result in an increase in fan energy (or other energy used to cool a space) that would result in greater total building energy use than was saved at the chiller.

Integrated control layer 118 can be configured to provide feedback to demand response layer 114 so that demand response layer 114 checks that constraints (e.g., temperature, lighting levels, etc.) are properly maintained even while demanded load shedding is in progress. The constraints can also include set-point or sensed boundaries relating to safety, equipment operating limits and performance, comfort, fire codes, electrical codes, energy codes, and the like. Integrated control layer 118 is also logically below fault detection and diagnostics layer 116 and automated measurement and validation layer 112. Integrated control layer 118 can be configured to provide calculated inputs (e.g., aggregations) to these higher levels based on outputs from more than one building subsystem.

Automated measurement and validation (AM&V) layer 112 can be configured to verify that control strategies commanded by integrated control layer 118 or demand response layer 114 are working properly (e.g., using data aggregated by AM&V layer 112, integrated control layer 118, building subsystem integration layer 120, FDD layer 116, or otherwise). The calculations made by AM&V layer 112 can be based on building system energy models and/or equipment models for individual BMS devices or subsystems. For example, AM&V layer 112 can compare a model-predicted output with an actual output from building subsystems 128 to determine an accuracy of the model.

Fault detection and diagnostics (FDD) layer 116 can be configured to provide on-going fault detection for building subsystems 128, building subsystem devices (i.e., building equipment), and control algorithms used by demand response layer 114 and integrated control layer 118. FDD layer 116 can receive data inputs from integrated control layer 118, directly from one or more building subsystems or devices, or from another data source. FDD layer 116 can automatically diagnose and respond to detected faults. The responses to detected or diagnosed faults can include providing an alert message to a user, a maintenance scheduling system, or a control algorithm configured to attempt to repair the fault or to work-around the fault.

FDD layer 116 can be configured to output a specific identification of the faulty component or cause of the fault (e.g., loose damper linkage) using detailed subsystem inputs available at building subsystem integration layer 120. In other exemplary embodiments, FDD layer 116 is configured to provide “fault” events to integrated control layer 118 which executes control strategies and policies in response to the received fault events. According to an exemplary embodiment, FDD layer 116 (or a policy executed by an integrated control engine or business rules engine) can shut-down systems or direct control activities around faulty devices or systems to reduce energy waste, extend equipment life, or ensure proper control response.

FDD layer 116 can be configured to store or access a variety of different system data stores (or data points for live data). FDD layer 116 can use some content of the data stores to identify faults at the equipment level (e.g., specific chiller, specific AHU, specific terminal unit, etc.) and other content to identify faults at component or subsystem levels. For example, building subsystems 128 can generate temporal (i.e., time-series) data indicating the performance of BMS 100 and the various components thereof. The data generated by building subsystems 128 can include measured or calculated values that exhibit statistical characteristics and provide information about how the corresponding system or process (e.g., a temperature control process, a flow control process, etc.) is performing in terms of error from its set-point. These processes can be examined by FDD layer 116 to expose when the system begins to degrade in performance and alert a user to repair the fault before it becomes more severe.

### Interface Customization Manager

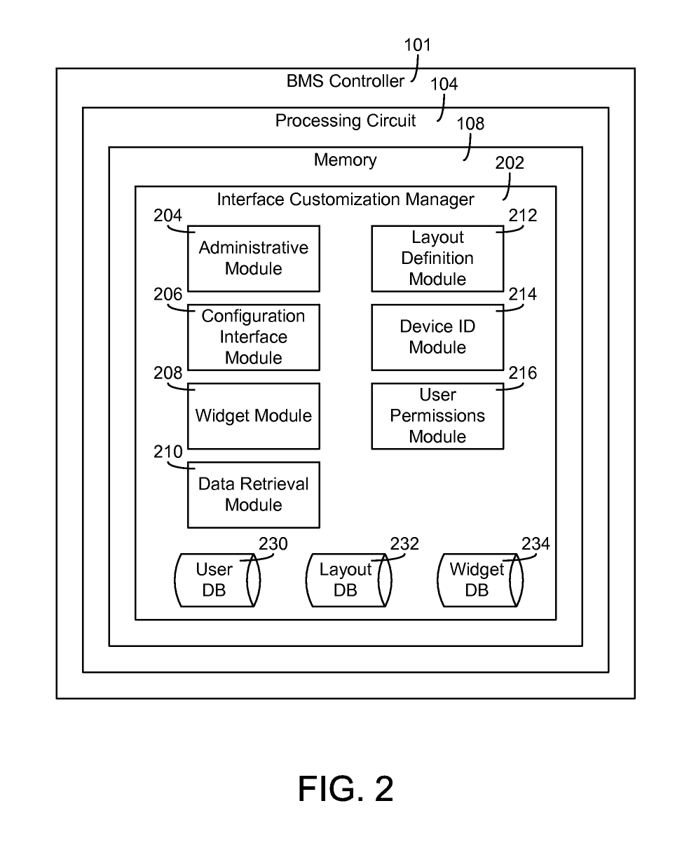

Referring now to FIG. 2, a detailed block diagram of BMS controller 101 is shown in greater detail. More particularly, memory 108 of BMS controller 101 is shown to include an interface customization manager 202. While FIG. 2 describes interface customization manager 202 in greater detail, it should be understood that BMS controller 101 and memory 108 may further include any number of managers, sub-systems, and modules, and may provide various BMS features for a building or building area beyond what is described in the present disclosure.

Interface customization manager 202 may generally be configured to allow for customization of an interface that can be presented on a user device relating to a BMS. As described above, a user may access the interface via any type of user device to access information about one or more spaces or equipment within the BMS. Interface customization manager 202 may allow a user (e.g., an administrator) to customize the interface to be presented to a particular user. For example, the content displayed in the interface may be varied based on the responsibilities of the user viewing the interface, the layout of the information on the interface may be varied based on the type of user device being used to view the information, and the like.

Interface customization manager 202 includes an administrative module 204. Administrative module 204 is generally be configured to control access to interface customization manager 202. For example, only some users may be allowed to create and modify custom interfaces that can be presented to various users of a building area. Administrative module 204 provides access to only certain users for the creation of the custom dashboard interfaces. Administrative module 204 provides access to a configuration interface that can be used by an administrator (or other user) to customize interfaces, as described below. Once the administrator is verified by administrative module 204, the administrator may be allowed to configure user interfaces for various users as described below.

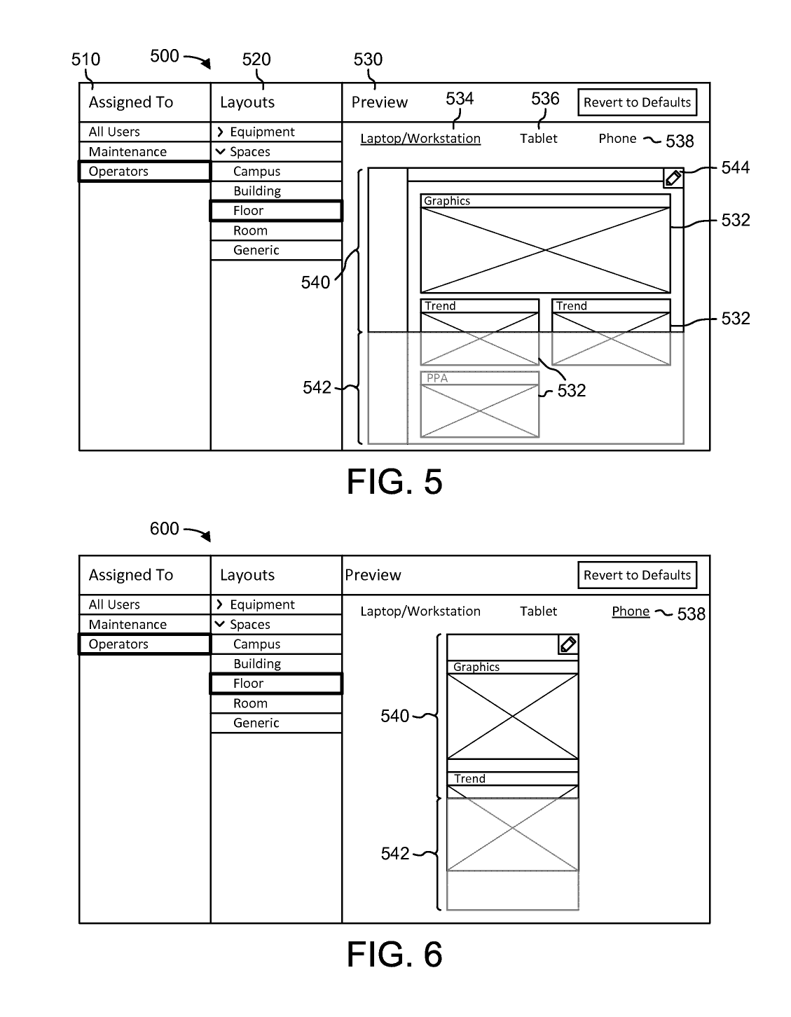

Interface customization manager 202 includes a configuration interface module 206. Configuration interface module 206 is generally configured to provide a configuration interface to the administrator upon interface customization manager 202 verifying the administrator. The configuration interface can allow the administrator to create and modify user interfaces for various users as generally described in the present disclosure. The configuration interface may display options for the administrator such as one or more users or types of users that the administrator can select, one or more building areas or equipment, and the like. Configuration interface module 206 may generally allow the administrator to provide input to interface customization manager 202 with respect to the activities of the other modules as described below. The activities facilitated by configuration interface module 206 are shown in greater detail in FIGS. 5-7.

Interface customization manager 202 includes a widget module 208. Within a user interface generated for a user by interface customization manager 202, one or more widgets may be displayed within the interface. Each widget can provide information relating to a particular space in a building, a particular system or sub-system, or a particular piece of equipment. For example, a widget may relate to a specific floor in a building, a specific room in a building, or a number of rooms in a building. As another example, a widget may relate to an HVAC system, a lighting system, or a security system, either for a whole building or for one or more rooms within the building. As another example, a widget may relate to a specific piece of equipment within a building sub-system.

Widgets can present information relating to a current operating status of a system, accept a user input relating to a change in operation of a piece of equipment or sub-system, present a report with data relating to previous operation of a piece of equipment or sub-system, present a schedule relating to operation of a sub-system, or provide alarms or warnings to a user. For example, widgets associated with an HVAC system may present a current temperature and other current conditions in one or more rooms via the interface, may allow a user to change a temperature setpoint of a room based on the current setpoint or the current occupancy of the room, or may present a schedule detailing future temperature setpoints for a room. As another example, widgets associated with a lighting system may present a report about energy usage related to the use of the lights in a room, may allow a user to adjust the lighting in a room, and the like. As another example, widgets associated specifically with a room in a building area may display the current temperature and lighting settings for the room, along with one or more controls for adjusting the temperature and lighting within the room. It should be understood that widgets may generally present any type of information relating to the operation of any equipment or sub-system in a BMS, over any type of area within a building.

An administrator, when creating or modifying a user interface, can choose one or more widgets to be displayed on the user interface. In some embodiments, the administrator may assign one or more users to an individual widget or a plurality of related widgets. As an example, the administrator may identify a user who should be responsible for the oversight of a room, and assign the user to a widget related to controlling the environment in the room.

In some embodiments, the administrator may assign all users with a specific task, job title, or other attribute to one or more widgets. For example, all security personnel within a building may be assigned to one or more security-based widgets by the administrator. Widget module 208 can be configured to receive a defined task, job title, etc. from the administrator and to identify all users who have such an attribute.

In some embodiments, the administrator may identify a piece of equipment. Widget module 208 may then identify all widgets that may be related to the piece of equipment. For example, the administrator may identify a chiller of an HVAC system for which a particular user is responsible for maintaining or supervising. Widget module 208 may identify one or more widgets related to the chiller and HVAC system that may be relevant to the user. The administrator may then select the widget to be displayed on a user interface for the user, or widget module 208 may assign the widget to the user.

In some embodiments, the administrator may identify a particular room (or other building space). Widget module 208 may identify one or more widgets related to the room (e.g., a widget for controlling the temperature and lighting in the room). The administrator may then select the one or more widgets to be assigned to a user scheduled to occupy the room at a future time. The user may be assigned to the room permanently, or may only be assigned to the room for a time at which he/she is scheduled to occupy the room.

In some embodiments, the administrator may identify off like pieces of equipment in a building. For example, the administrator may identify all lighting fixtures in a building, and all lighting zones in a building. The administrator may then select widgets relating to the lighting fixtures to be assigned to a user responsible for monitoring and maintaining the lighting system of the building. In other words, the administrator allows a user responsible for a building system to view all components of the building system regardless of the location of each of the components.

In general, widget module 208 is configured to facilitate the process of assigning one or more widgets to one or more users. The administrator may provide any type of input to widget module 208 to facilitate the assigning process. For example, the administrator can identify users, widget module 208 may identify widgets that may have content related to the user, and then the administrator may select some or all of the widgets for display for the user on a user interface. As another example, the administrator can identify a piece of equipment, a sub-system, or a building area, widget module 208 may identify widgets that may have related content, and then the administrator may select some or all of the widgets for display for a user on a user interface.

Some widgets may be viewable by all users, in some embodiments. For example, a widget providing information about a general status of a building or building area may be presentable to all users in the building or building area, regardless of the role of the user. While the present disclosure describes many examples of assigning widgets to a subset of users, it should be understood that the assigning of widgets to users may vary in various embodiments, and that in some embodiments some widgets may be assigned to all users.

Some types of widgets may be viewable only by some users, in some embodiments. For example, widgets configured to show a graph or chart indicating the current performance of a system or equipment may be viewable by all users, while widgets configured to allow management of such a system or equipment may only be viewable by designated operators. As another example, a widget may be configured to display information related to an identified potential problem area (e.g., an area which requires a user input in response to an unusual situation). Such a widget may only be viewable by an administrator or operator, in some embodiments.

Interface customization manager 202 includes a data retrieval module 210. When a user logs in to interface customization manager 202 to access a user interface, the user may be presented with one or more widgets as identified by the administrator and widget module 208. Data retrieval module 210 is configured to retrieve data from one or more building subsystems 128 and to populate the widgets. For example, if a widget is related to the current environment in a room (e.g., temperature and lighting), data retrieval module 210 can retrieve data from HVAC system 140 and lighting system 142 to display on the widget.

In some embodiments, data retrieval module 210 may receive alarm or warning information. Data retrieval module 210 may then be configured to identify one or more widgets in which the alarm or warning information can be presented, and one or more other modules can then subsequently generate the widget with the alarm or warning information for display on a user interface.

Interface customization manager 202 includes a layout definition module 212. In addition to selecting one or more widgets to be displayed on an interface for a given user, the administrator can further determine a layout of the widgets and information on the interface. Layout definition module 212 can receive input from the administrator relating to the position of the widgets, the size of each widget, the layout of information within each widget, and the like.

In some embodiments, the administrator or layout definition module 212 may determine the position of each widget on an interface. For example, if the user viewing the user interface is responsible for security in a building area, a widget related to current alarms and warnings may be placed at the top of the user interface, or a widget providing a current view or data from a security camera may be placed at the top of the interface. The administrator or layout definition module 212 may identify one or more widgets which are relatively more important than other widgets, and position them accordingly on the user interface.

In some embodiments, the administrator or layout definition module 212 may determine the size or dimensions of each widget on an interface. For example, if multiple widgets are to be displayed on a user interface, the dimensions of each widget may be adjusted in order to fit all widgets on the user interface.

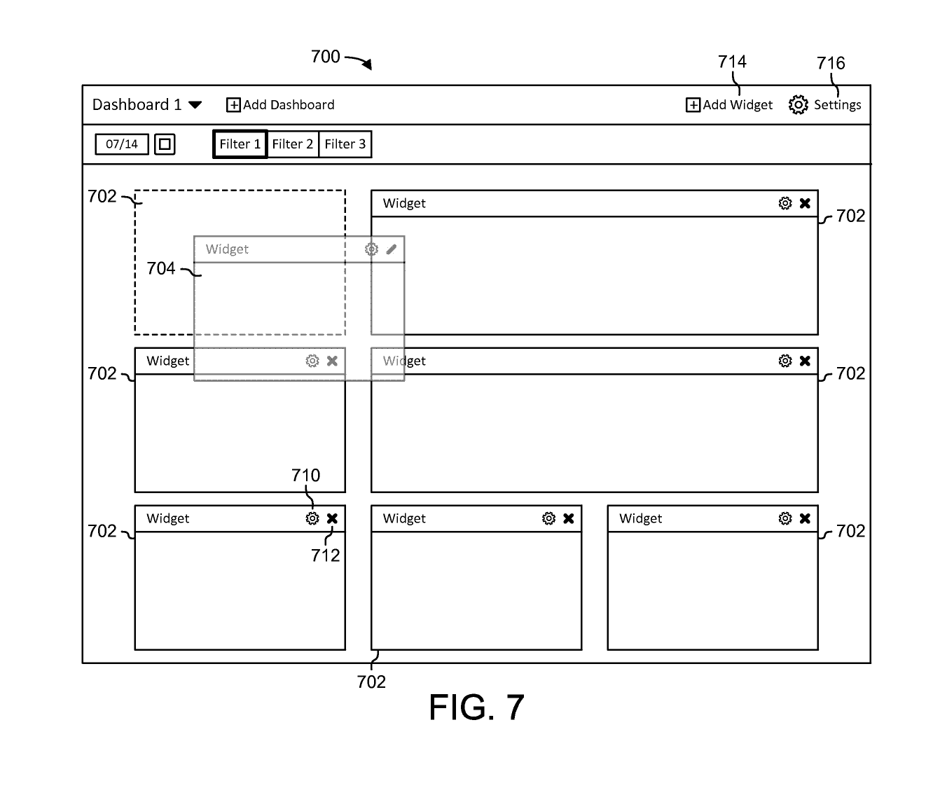

In some embodiments, the dimensions and size of each widget may be adjusted without restriction (i.e., the dimensions and size of each widget may not be constricted by any attribute of the layout outside of the overall size of the layout). For example, a widget may be resized to fill the entire screen. In other embodiments, the editing of each widget may be constricted by one or more attributes of the layout. For example, it may be predetermined for a layout for a workstation screen that there are twelve available slots for widgets on a screen. Widgets may be moved to and from one of the available slots, or may be resized to occupy a single slot or multiple slots (but cannot occupy just a portion of a slot). Such an embodiment is described in greater detail in FIG. 7.

In some embodiments, the administrator or layout definition module 212 may take into account the type of device being used to access the user interface, and/or the type of display being used to view the user interface. For example, a monitor for a desktop may be larger than a monitor for a laptop, which may be larger than a screen on a mobile device. The administrator and layout definition module 212 may take into account the type of device being used to view the user interface, and may adjust the layout of the widgets accordingly. In some embodiments, the administrator or layout definition module 212 may assign different layouts to different users.

As one example, for a mobile device with a smaller screen, graphs or charts may be presented as an efficient way to convey information in a limited space. However, for a laptop or desktop with more screen space, the same information may be presented in a table. As another example, the size of text and icons in each type of display may vary, based on the space available in each display. In other words, views that may make sense for a mobile device may not make sense for a laptop or desktop. Layout definition module 212 may be configured to determine which type of view for a widget is appropriate given the device accessing the widget.

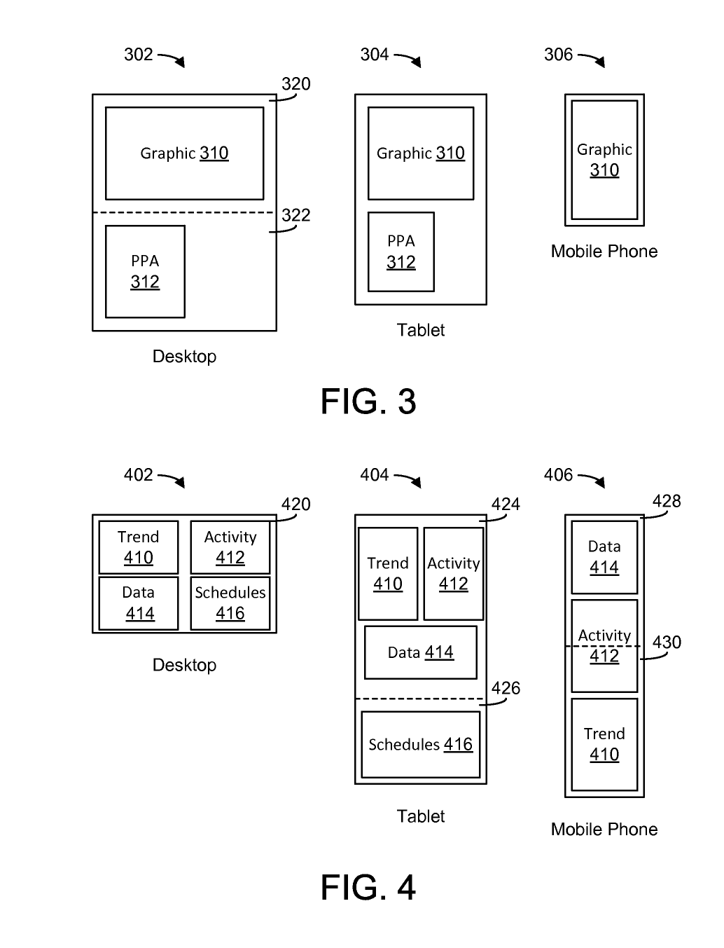

In some embodiments, the user interface generated for a user by interface customization manager 202 may be scrollable. In other words, the user interface can include an “active” portion being displayed on the device being used by the user, and an “inactive” portion which can be accessed by the user scrolling on the device. The administrator and layout definition module 212 may determine which widgets are initially displayed in the active portion of the user interface and which widgets are initially displayed in the inactive portion of the user interface. The activities of layout definition module are described in greater detail with reference to FIGS. 3-4.

In some embodiments, layout definition module 212 may provide the administrator with a plurality of template layouts from which an administrator can select a layout, or modify a layout. Each layout suggested or provided by layout definition module 212 may include different widgets, and may be tailored to a specific equipment or space. As one example, one layout provided by layout definition module 212 may relate to a specific floor in a building, or in a specific room. As another example, one layout provided by layout definition module 212 may relate to a specific piece of equipment. The administrator may select one of the template layouts for presentation to a specific user, or may select a template layout and modify the layout for the specific user.

Interface customization manager 202 includes a device identification (ID) module 214 configured to determine the type of user device attempting to access a user interface. Upon determining the type of user device, a layout generated by layout definition module 212 for the user device may be selected and generated on the user device.

Interface customization manager 202 includes a user permissions module 216. As described above, the user may only have access to certain widgets as determined by at least one of the administrator and interface customization manager 202. User permissions module 216 is configured to identify a user attempting to access a user interface and to determine the permissions of the user. The user may be identified in any way. For example, the user may be identified via the user device being used to access interface customization manager 202 (i.e., the user device is assigned to a particular user, or a particular type of user with a defined role). As another example, the user may enter a username, password, or other login credentials which may be identified by user permissions module 216. In some embodiments, user permissions module 216 may use the credentials by comparing the credentials to stored data in a user database 230, and determine user permissions accordingly.

Interface customization manager 202 includes a layout database 232. Layout database 232 can generally be configured to store layout information for a plurality of layouts for a plurality of users. For example, for a given user or type of user specified by the administrator, layout database 232 may store a layout for each type of user device that can be used to access a user interface. For a given user, a desktop screen layout, a tablet layout, and a mobile device layout may be stored, each layout including its own individual settings. Layout database 232, for each layout, may store the configuration of each widget within the layout.

Interface customization manager 202 includes a widget database 234. In some embodiments, widget database 234 may be accessed by widget module 208 or layout definition module 212 to access widgets that can be provided on a user interface. In some embodiments, an administrator may create a widget to be stored in widget database 234. For example, the administrator may create a widget by identifying a space, equipment, or system associated with the widget, along with what information should be presented within the widget. The widget can then be accessed later by the administrator or by widget module 208, in order to be selected for presentation on a particular layout or user interface.

Referring now to FIGS. 3-4, example layouts that can be generated by layout definition module 212 are illustrated. Referring to FIG. 3, an example layout chosen for a particular user is shown for a desktop screen 302, a tablet 304, and a mobile phone 306. Each device may have a different size screen, and a different layout may be chosen by layout definition module 212. As described above, an administrator may have specified each of the layouts for each type of device for the user. In other words, the administrator may determine the layout of information on each device, each layout on each device being different.

In the embodiment of FIG. 3, the administrator has chosen two widgets for display for the user interface, both widgets relating to a building space. A graphic widget 310 and a potential problem area (PPA) widget 312 are shown as part of the user interfaces. Graphic widget 310 may illustrate, for example, a graph or chart including various data points, while PPA widget 312 might identify a potential problem to be addressed by the user.

As shown in FIG. 3, in the layout on desktop screen 302, the screen may be scrollable. The administrator has chosen graphic widget 310 to be displayed in an active portion 320 of the device, while PPA widget 312 is displayed in an inactive portion 322. The administrator (or widget module 208 or layout definition module 212) may determine the dimensions and size of each widget 310, 312 such that the size of each widget is maximized on the screen.

On tablet 304, the administrator is shown to have chosen a layout that displays both widgets 310, 312 at the same time. Since scrolling may be more difficult on a tablet, the administrator may determine it is advantageous to display both widgets on tablet 304 instead of just one, despite likely having to adjust the size of each widget in order to fit both on the screen.

On mobile phone 306, the administrator (or layout definition module 212) may determine that both widgets 310, 312 cannot fit on the screen because of size limitations. Therefore, only graphic widget 310 is shown displayed, while the user viewing the interface may have to provide a command or selection to cause PPA widget 312 to be displayed on the screen.

As shown in FIGS. 3-4, the dimensions and size of each widget on each interface may vary based on the amount of space available on the display of the user device. In some embodiments, the size of a widget may not vary, or may not be enlarged beyond a threshold, if the enlarged view obscures the information being presented. In some embodiments, the size of each widget may be expanded to fill the entire space available on the screen of a device.

In the embodiment of FIG. 4, user interfaces are illustrated that may be generated for a user managing the operation of a system is shown. For example, the user may be managing a VAV unit of a HVAC system. The administrator may choose various widgets relating to the VAV unit for display on the user interfaces, such as a trend widget 410, an activity widget 412, a data widget 414, and a schedule widget 416 shown various information such as recent activity of the VAV unit, recent trends, and a schedule detailing upcoming activity of the VAV unit.

Again, the administrator and layout definition module 212 may set three different layouts for the three types of user devices. On desktop screen 402, it may be determined that all widgets can fit on the screen at once. However, on tablet 404, it may be determined that schedule widget 416 should be displayed in an inactive portion 426 as it cannot fit with the other widgets displayed in active portion 424.

On mobile phone 406, data widget 414 is shown in an active portion 428. However, since the other three widgets cannot be fit into the screen, it may be determined that the user can scroll to access the other widgets. A portion of a second widget, activity widget 412, is shown in active portion 428, and the user may scroll down to view the rest of activity widget 412, along with the other widgets that are initially loaded in inactive portion 430. Further, it may be determined that a schedule widget cannot be configured to fit the small size of the display, and therefore may not be provided at all for display. In various embodiments, the display may provide a link or other method of allowing the user to access information normally provided on a schedule widget.

Note that in some embodiments, the order of widgets being displayed may vary based on the type of user device. For example, for mobile phone 306, since only one widget can be displayed, the administrator may choose a first widget (data widget 414). However, on a desktop screen 402 where multiple widgets can fit, the administrator has chosen two other widgets (trend widget 410, activity widget 412). The order of widgets being displayed may vary based on preferences indicated by the administrator, or settings determined by widget module 208 or layout definition module 212.

Using the systems and methods described in the present disclosure, an administrator can create multiple user interfaces for a single user (or a single user group). For example, the administrator may create an first interface for a piece of equipment, a second interface a building room, and a third interface for an entire floor, each of the interfaces having a different layout and being accessible by the user at any time. Further, each of the three interfaces may be three individual layouts, each layout based on the type of device the user is using (e.g., desktop, tablet, and mobile device). In this way, the administrator may create any number of user interfaces that may be accessible by a user, dependent upon the device the user is using to view the interfaces and the information that the user wishes to view.

While the embodiments described in the present disclosure describe an administrator as configuring a user interface for a user, in other embodiments other users may configure a user interface for himself or herself, or for another user. For example, a user may indicate one or more preferences to interface customization manager 202, which may be used to customize the user interface presented to the user. In some embodiments, the user may have the ability to fully or partially customize their user interface, while in other embodiments the administrator may have full control.

### Configuration Interfaces

As described above, an administrator may create and modify a user interface to be presented for a user, including providing various parameters related to the widgets to be presented within the user interface and the content in each widget. Interface customization manager 202 and more particularly configuration interface module 206 is generally configured to provide a configuration interface for allowing the administrator or create and modify the user interface. Referring generally to FIGS. 5-7, example configuration interfaces that can be presented to an administrator are illustrated.

Referring to FIG. 5, an example configuration interface 500 is described in greater detail. In the embodiment of FIG. 5, configuration interface 500 is shown to include a section 510 for selection of a user role, a section 520 for selection of a template layout, and a preview section 530 for previewing a particular user interface layout.

In section 510, the administrator can assign one or more group of users to which the current user interface can be assigned. For example, some user interfaces created by the administrator may be accessible by all users associated with the BMS, only with maintenance personnel, or with operators (e.g., managers or other supervisory personnel). Further, the administrator may be allowed to select one or more sub-groups of users within each category, or may be able to select individual users.

In section 520, the administrator can select from one or more template layouts provided by interface customization manager 202. For example, interface customization manager 202 may provide the administrator with various example layouts, each layout associated with a particular piece of equipment or space. As shown in FIG. 5, the administrator may select a layout for an entire campus, a building, a floor within a building, or a room within a building. The layout may be configured to provide information relating to the equipment or space identified.

In section 530, the layout selected by the administrator can be previewed by the administrator. As shown in FIG. 5, the selected layout including multiple widgets 532 is shown. In some embodiments, the layout to be presented to a user on a user interface may vary based on the type of device being used to access the user interface. As shown in FIG. 5, the administrator can select a laptop/workstation layout 534, a tablet layout 536, or a phone layout 538 to view.

As shown in FIG. 5, the administrator has selected laptop/workstation layout 534 to view. In the layout, not all widgets 532 can fit on the screen, and some widgets are shown partially or wholly in an active portion 540 of the user interface while other widgets are shown partially or wholly in an inactive portion 542 of the user interface.

In some embodiments, configuration interface 500 provides an edit button 544. Upon selection of edit button 544, the administrator may be provided with an interface (such as that shown in FIG. 7) for editing the layout.

Referring to FIG. 6, in configuration interface 600, the administrator is shown to have selected phone layout 538 to view. Compared to laptop/workstation layout 534, the size of the layout is different to account for the different dimensions of the screen of the phone. The user interface on the phone may still include an active portion 540 and an inactive portion 542.

Referring now to FIG. 7, a configuration interface 700 is shown in which the size and location of each widget on a user interface can be modified by an administrator. The administrator can reach configuration interface 700 upon indicating that he or she would like to modify the layout of the user interface (e.g., via edit button 544). Within configuration interface 700, widgets can be added, removed, repositioned, and resized to create a customized layout for the user interface.

As shown in FIG. 7, the layout can include a plurality of slots 702 in which a widget can be placed. In some embodiments, each slot 702 can be the same size, while in other embodiments the size of each slot 702 may vary. Widgets may be configured to only fit in a single slot, or may be configured to fit into multiple slots. The administrator can drag a widget from a first slot to a second slot, may swap two widgets located in two different slots, may expand or contract the size of a widget to occupy more or less slots, and the like. For example, as shown in FIG. 7, a widget 704 can be dragged from a slot 702 to another location on the interface.

Each widget is shown to include a settings icon 710, which upon selection by an administrator may cause configuration interface 700 to present a plurality of settings and options that can be applied to the widget. Each widget further includes a delete icon 712 that allows the administrator to remove a widget from the layout. Configuration interface 700 may further include various options such as an add widget option 714 that can allow an administrator to add a new widget to the interface, a settings option 716 that allows the administrator to change global settings, and the like. It should be understood that configuration interface 700 may further include any number of controls, icons, buttons, and the like that allows the administrator to add, remove, reposition, and resize widgets in the layout in any way.

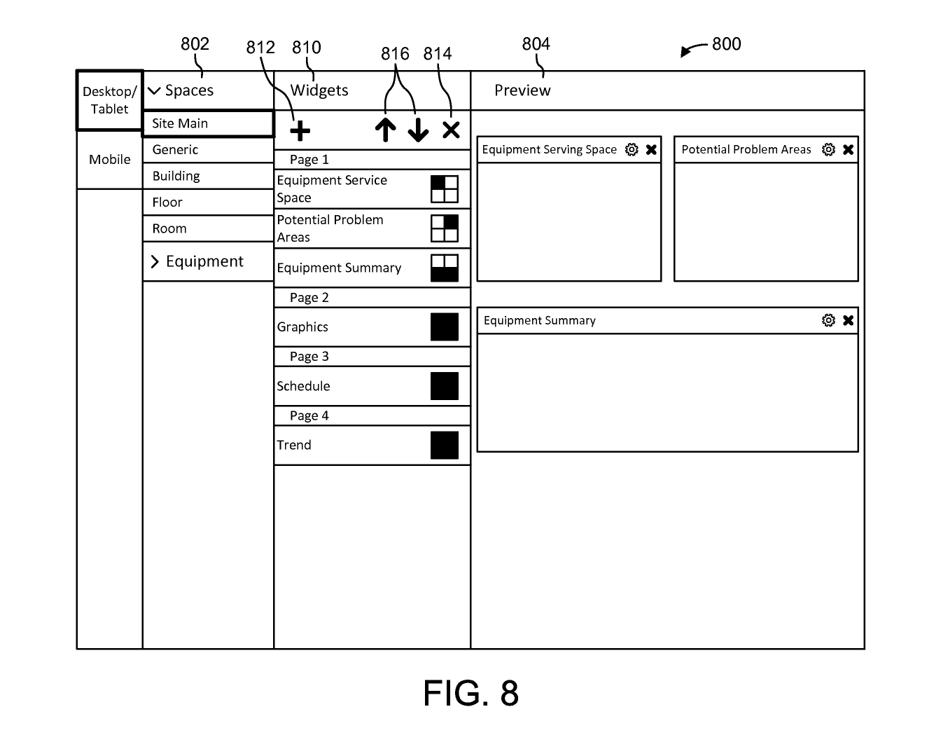

Referring now to FIG. 8, another example configuration interface 800 is shown. In the embodiment of FIG. 8, the process of changing the layout of the widgets on the user interface is shown in greater detail. As shown in configuration interface 800 and more particularly menu 802, the administrator has chosen to modify a user interface configured to show main information about a building space (e.g., about a campus as a whole, instead of a specific building, floor or room). Configuration interface 800 further includes a preview section 804 for viewing the current layout specified by the administrator.

In the embodiment of FIG. 8, the administrator can use widget section 810 to adjust the placement of widgets on the user interface, along with determining which widgets are to be displayed on a first page (e.g., an active portion of the display). As described above, since all widgets to be provided as part of a user interface may not all fit on the screen together, some widgets may be designated to only display on the screen upon a user scrolling to the widgets. In the embodiment of FIG. 8, the administrator has selected three widgets to appear on a first page on a screen (the widgets “equipment service space” and “potential problem areas” taking up one slot of four available spots on the page, and the widget “equipment summary” taking up two slots). In various embodiments, each page may include any number of available slots.

The administrator may add any number of pages, which may be accessible to a user by either scrolling or by selecting a link or button to be taken to a different page. As shown in FIG. 8, a graphics widget may be accessed on the second page, a schedule widget may be accessed on the third page, and a trend widget may be accessed on the fourth page. The administrator may add any number of pages to the user interface, and may specify any method of scrolling to or selecting the additional pages for viewing.

Within widget section 810, the administrator can select the add button 812 or delete button 814 to add or remove widgets, respectively. Widget section 810 further includes arrows 814 that allows the administrator to move individual widgets to different pages, or to different slots within the same page. For example, the administrator can select an individual widget in the list and then select arrows 814 to move the widget up or down a page. It should be understood that configuration interface 800 and widget section 810 may include any number of selectable elements that allow the administrator to move widgets across slots and pages.

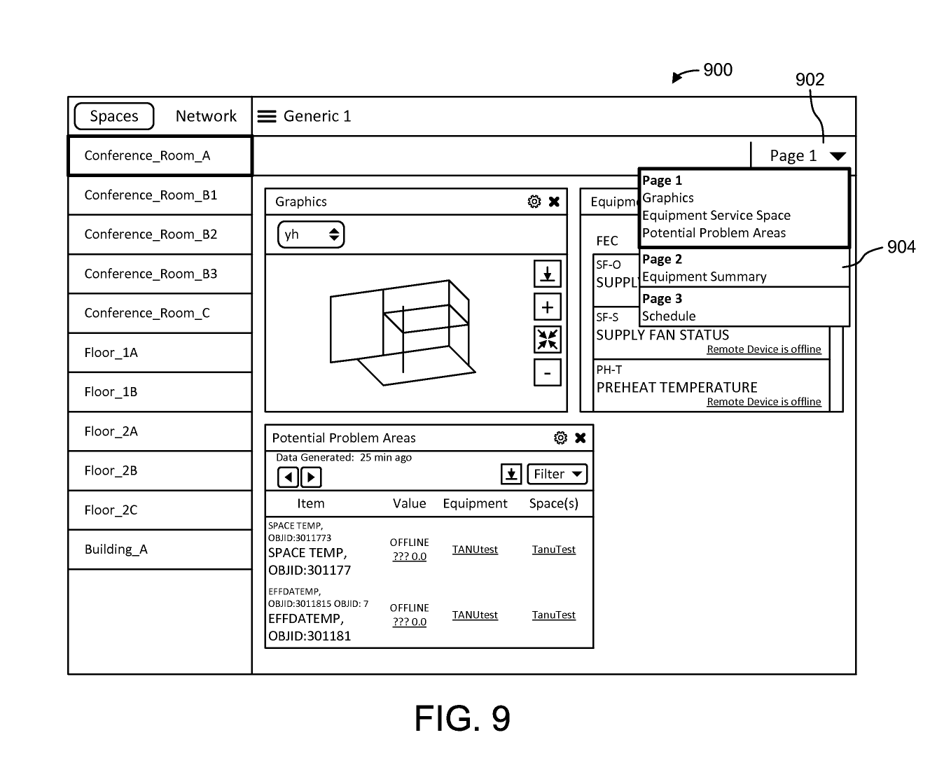

Referring to FIG. 9, another example configuration interface 900 is shown. In the embodiment of FIG. 9, an example method of changing pages in the user interface is shown. After the setup of the user interface, content is designated for presentation on one or more pages, with a first page initially provided on user interface 900. In the example shown in FIG. 9, the user has been assigned a number of spaces (e.g., “Conference_Room_A”, “Conference_Room_B1”, and so forth) that the user is responsible for maintaining or monitoring. The user may select a space to view information about the space via a plurality of widgets.

The user may select a button 902 that causes a drop-down menu 904 to be presented on the user interface. Via drop-down menu 904, the user may select a different page for viewing on user interface 900. Drop-down menu 904 may include a brief description of the content on each page (e.g., a second page may include a detailed equipment summary, a third page may include a schedule for operation of the various equipment in a building area, etc.). Drop-down menu 904 may further optionally include any options relating to how the content is displayed on the user interface, may allow the user to select individual widgets from a page for display, and the like.

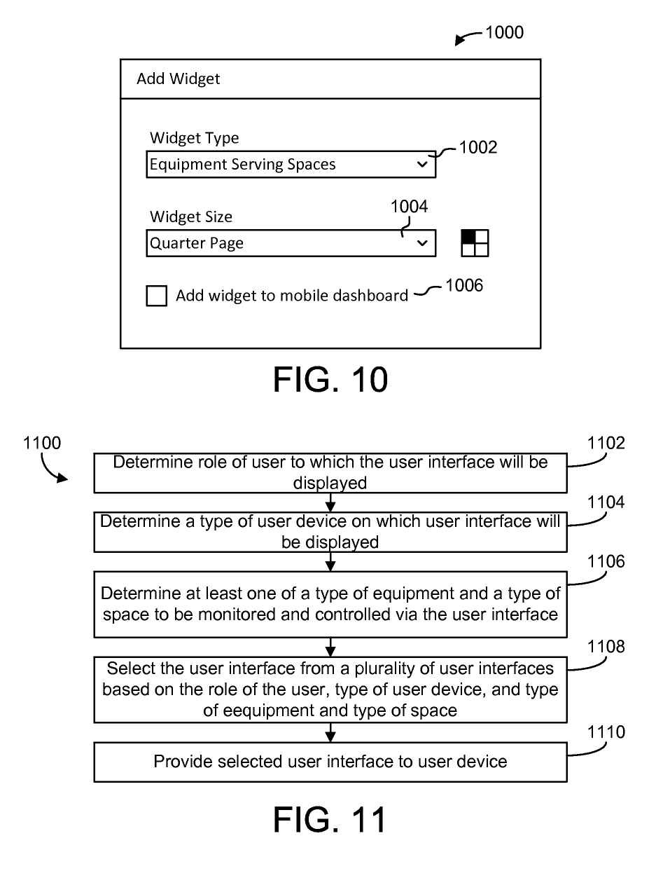

Referring to FIG. 10, an example interface 1000 is shown that may be presented to the administrator upon the selection of add button 812. Upon the selection of adding a new widget, the administrator may be presented with various options for the new widget based on the type of layout on which widget is being added.

For example, in interface 1000, the administrator is wishing to add a widget to a user interface for a desktop or tablet screen. Interface 1000 includes a drop-down menu 1002 allowing the administrator to select the widget type. The widget type may identify, for example, a specific type of report (e.g., a trend report, an equipment service spaces report, a PPA report, etc.). The administrator can also specify a default size of the widget via drop-down menu 1004. The size of the widget may or may not be fixed or partially fixed, in various embodiments. For example, if the administrator was adding a widget to a mobile device user interface, the user interface layout may only be able to fit one widget on a screen at a time, therefore automatically causing the size of the widget to be a specific size to fit the layout.

The administrator may also choose to add the widget to a user interface for a mobile device via option 1006. In other words, even though the administrator is creating the widget for a desktop or tablet screen, the administrator can, at the same time, add the same widget to the user interface for the mobile device. In some embodiments, the widget may already exist on the mobile device user interface, so the option may not be presented or interface 900 may indicate as such to the user.

In some embodiments, the administrator may choose to add a widget related to a specific piece of equipment, or a BMS sub-system. The configuration interface provided to the administrator may be configured to allow the administrator to search for the equipment or sub-system. For example, the equipment in a BMS may be networked and interconnected, such that a user can search for a specific piece of equipment within the BMS. The configuration interface may allow the administrator to search for and select a specific piece of equipment for a new widget. BMS controller 101 may then be configured to retrieve information related to the piece of equipment to populate the widget.

Referring now to FIG. 11, a flow chart of a process 1100 for configuring a user interface to be displayed on a user device is shown, according to some embodiments. Process 1100 may be executed by, for example, interface customization manager 202. The user interface to be displayed on the user device may be configured to allow for the monitoring and controlling of building equipment and spaces in a BMS.

Process 1100 includes determining a role of a user to which the user interface will be displayed (1102). At 1102, the user may log in or otherwise provide credentials to the interface customization manager that allows the manager to identify the user and the user role. In some embodiments, the interface customization manager may identify the role of the use via a user device identifier. A user role may include an administrative, managerial, or other such supervisory role, a maintenance role, or a tenant role (e.g., a regular occupant).

Process 1100 includes determining a type of the user device on which the user interface will be displayed (1104). At 1104, the interface customization manager may determine if the user device is, for example, a workstation, a desktop, a laptop, a tablet, a mobile device, etc. At 1104, the interface customization manager may use the device type to determine a size of the screen that will display the user interface, along with any other display properties that may impact the presentation of the user interface on the user device.

Process 1100 includes determining at least one of a type of equipment and a type of space to be monitored and controlled via the user interface (1106). At 1106, the interface customization manager may identify one or more equipment or spaces that are relevant to the user based on the user role. For example, for a maintenance role, the interface customization manager may identify one or more pieces of equipment needing maintenance or attention. As another example, for a tenant role, the interface customization manager may identify one or more working spaces of the user.

Process 1100 includes selecting the user interface from a plurality of user interfaces based on the role of the user, the type of the user device, and at least one of the type of equipment and the type of space (1108). At 1108, the interface customization manager may select a user interface which includes one or more widgets, wherein each widget is configured to provide information relating to the equipment or spaces identified at 1106. Each widget may relate to a specific space, multiple spaces, a specific piece of equipment, all equipment in a specific space, or all equipment relating to a particular subsystem of the building management system. A space may include a room, multiple rooms, a floor level, a building, or multiple buildings. A subsystem may include, for example, a heating, venting, and air conditioning (HVAC) system, a security system, a lighting system, or a fire alerting system.

In some embodiments, the interface customization manager may allow an administrator to create or modify user interfaces, and may choose one such user interface at 1108. For example, the administrator can change user permissions relating to the user interface or of a widget within the user interface. As another example, the administrator can add, remove, resize, or reposition widgets within the user interface.

Process 1100 includes providing the selected user interface to the user device (1110). The user interface may have a layout tailored specifically for the user device. The interface customization manager may include a layout definition module that allows different layouts to be created for a user interface based on the type of user device displaying the user interface. Each layout may have different placements and sizes of the various widgets to be displayed on the user interface.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can include RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A building management system comprising:
building equipment configured to serve one or more spaces in a building or campus;
a user device configured to display a user interface for monitoring and controlling the building equipment and the one or more spaces; and
a controller configured to:
determine a role of a user to which the user interface will be displayed;
determine a type of the user device on which the user interface will be displayed;
determine at least one of a type of equipment and a type of space to be monitored and controlled via the user interface;
select the user interface from a plurality of user interfaces based on the role of the user, the type of the user device, and at least one of the type of equipment and the type of space, each of the plurality of user interfaces corresponding to a different combination of user role, user device type, and at least one of equipment type and space type; and
provide the selected user interface to the user device.

2. The building management system of claim 1, wherein each of the plurality of user interfaces comprises one or more widgets;
wherein each widget is configured to provide information relating to a specific space, multiple spaces, a specific piece of equipment, all equipment in a specific space, or all equipment relating to a particular subsystem of the building management system.

3. The building management system of claim 2, wherein a space comprises one of a room, multiple rooms, a floor level, a building, or multiple buildings.

4. The building management system of claim 2, wherein a subsystem is one of a heating, venting, and air conditioning (HVAC) system, a security system, a lighting system, or a fire alerting system.

5. The building management system of claim 2, wherein the controller is further configured to receive a user input from the user relating to the layout of information on the selected user interface;
wherein the user input relates to one of a request to add a widget to the user interface, remove a widget from the user interface, or change the layout of widgets on the user interface.

6. The building management system of claim 1, wherein the type of the user device comprises one of a workstation, a desktop, a laptop, a tablet, and a mobile device.

7. A building management system comprising:
building equipment configured to serve one or more spaces in a building or campus;
a user device configured to display a selected user interface for monitoring and controlling the building equipment and the one or more spaces; and
a controller configured to generate a plurality of user interfaces from which the selected user interface is selected, the controller comprising:
a widget module configured to generate a plurality of widgets, each of the widgets comprising information relating to at least one of the building equipment and the one or more spaces; and
a layout definition module configured to define a different layout for each of the plurality of user interfaces, wherein each layout comprises one or more of the widgets and corresponds to a different combination of a user role, a user device type, and at least one of an equipment type and a space type.

8. The building management system of claim 7, wherein the controller further comprises a user permissions module configured to define one or more user roles and to associate one or more of the widgets with each of the user roles.

9. The building management system of claim 8, wherein the layout definition module is configured to assign different layouts for each of the plurality of user interfaces based on the defined user roles, wherein each layout comprises different widgets based on the user roles associated with each widget.

10. The building management system of claim 7, wherein the controller further comprises a device identification module configured to define one or more types of user devices on which the plurality of user interfaces will be displayed and to associate one or more of the widgets with each of the user device types.

11. The building management system of claim 10, wherein the layout definition module is configured to assign different layouts for each of the plurality of user interfaces based on the defined types of user devices, wherein each layout comprises different widgets based on the types of user devices associated with each widget.

12. The building management system of claim 7, further comprising an administrative module configured to allow an administrative user to provide an input relating to the plurality of user interfaces.

13. The building management system of claim 12, wherein the input from the administrative user relates to at least one of:
the addition of a widget to a user interface;
the removal of a widget from a user interface;
a change in the size of a widget on a user interface;
a change in location of a widget on a user interface; and
content to be displayed within a widget on a user interface.

14. The building management system of claim 12, wherein the input from the administrative user relates to a selection of a user or group of users for which a particular user interface or a particular widget should be provided.

15. The building management system of claim 7, wherein determining a layout for a user interface comprises:
identifying the user device type and an amount of space on the screen of the user device on which one or more widgets can be displayed;
identifying one or more widgets to be displayed on the screen of the user device when the user device loads the user interface; and
identifying one or more widgets to be accessible on the user interface but not displayed on the screen of the user device when the user device loads the user interface.

16. The building management system of claim 7, wherein a space comprises one of a room, multiple rooms, a floor level, a building, or multiple buildings.

17. The building management system of claim 16, wherein a subsystem is one of a heating, venting, and air conditioning (HVAC) system, a security system, a lighting system, or a fire alerting system.

18. The building management system of claim 7, wherein the type of the user device comprises one of a workstation, a desktop, a laptop, a tablet, and a mobile device.

19. A method for configuring a user interface to be displayed on a user device, the user interface configured to allow for the monitoring and controlling of building equipment and spaces in a building management system, comprising:
determining a role of a user to which the user interface will be displayed;
determining a type of the user device on which the user interface will be displayed;
determining at least one of a type of equipment and a type of space to be monitored and controlled via the user interface;
selecting the user interface from a plurality of user interfaces based on the role of the user, the type of the user device, and at least one of the type of equipment and the type of space; and
providing the selected user interface to the user device.

20. The method of claim 19, wherein each of the plurality of user interfaces comprises one or more widgets;
wherein each widget is configured to provide information relating to a specific space, multiple spaces, a specific piece of equipment, all equipment in a specific space, or all equipment relating to a particular subsystem of the building management system.
